(19) United States
(12) Patent Application Publication
(10) Pub. No.: US 2011/0126691 A1
(43) Pub. Date: Jun. 2, 2011

(54) TUNABLE MOUTHPIECE FOR A BRASS INSTRUMENT

(76) Inventor: Scott Alvin Hartman, Stafford Springs, CT (US)

(21) Appl. No.: 12/887,442

(22) Filed: Sep. 21, 2010

Related U.S. Application Data
(60) Provisional application No. 61/244,268, filed on Sep. 21, 2009.

(51) Int. Cl. G10D 9/02

(52) U.S. Cl. 84/398

(57) ABSTRACT

Tunable mouthpiece of a brass instrument having a rim, a cup body, a throat tube insert, and a shanked backbore, wherein the throat tube insert is adjustably inserted into a backbore of the shanked backbore which forms a narrowest portion of the backbore.

### BACKGROUND OF THE INVENTION

1. Field of the Invention

The present invention relates to a mouthpiece of a brass instrument held to a performer's mouth when a trumpet, trombone, horn, tuba or the like is used.

2. Description of the Related Art

Mouthpieces for brass wind instruments have been produced for thousands of years. Most mouthpieces have been shaped from solid brass rod in which contiguously conjoined elements of a rim, a cup-chamber, a backbore, and an en external end-taper blend together with undivided bodies. Brass-wind mouthpieces were not considered to be interchangeable between brands of similar instruments until design standards of the 20^{th} century gained popularity. Lack of interchangeability had occurred because each manufacturer designed mouthpieces for use with their own instruments, mouthpiece length was considered arbitrary, manufactures used a variety of end tapers to connect mouthpieces with their instruments, and manufacturers expected musicians to use mouthpieces that were supplied with each instrument.

Since the early 20^{th} century, interchangeability of brass wind mouthpieces has been greatly facilitated by two design practices. Manufacturers started to use (1) generally accepted standards for overall length and external end taper (shank), in conjunction with (2) a common principle for “balancing” acoustical characteristics of a cup chamber with a backbore chamber within each mouthpiece body. U.S. Pat. No. 7,078,605 (2006) goes into great detail about balancing acoustical characteristics.

In the evolution of brass wind mouthpieces inventors started to make the individual parts (i.e. Rim, Cup, Throat, and Backbore) of the mouthpiece separable so that a performer/musician could pick the components that gave them the desired musical effect. A few inventors have utilized changeable mouthpiece components. U.S. Pat. No. 1,012,140 shows one cup may be made to serve a set of interchangeable tubular extensions of varying length and bore taper. U.S. Pat. No. 1,327,970 shows a separable mouth-piece in which provision is made for inserting a throat or bore which is specially adapted to use with a cornet, trumpet, alto-horn, baritone, trombone or bass instrument.

One problem with the mouthpieces having separable components is that a musician/performer would have to have multiple rims, cups, and backbore and interchange them in different combinations to produce the sound they desired. This is not only tiresome but these many pieces can cost a performer a lot of money. One method in dealing with this is having an adjustable cup. U.S. Pat. No. 2,758,497 shows a mouthpiece which can be quickly, easily and accurately adjusted by the musician to provide and desired depth of cup to suit the requirements of a particular musicians lips and the requirement of the musical score being interpreted by the musician. Similar adjustable cups are demonstrated in U.S. Pat. Nos. 2,062,792 and 2,273,177.

Most experimentation relating to brass mouthpieces have focused upon acoustic properties of the interior air chamber of the mouthpiece. This interior chamber functions as a Helmholtz resonator or Helmholtz oscillator, which is a container of gas (usually air) with an open hole (or neck or port). A volume of air in and near this open hole vibrates because of the ‘springiness’ of the air inside, creating a sound at a certain frequency. An empty bottle is a common example of a Helmholtz resonator; the air inside vibrates at a certain frequency when you blow across the top. A brass mouthpiece functions essentially the same way if you place the mouthpiece on your hand, sealing the cup closed, and then blow across the small opening at the opposite end. If you change the interior parameters of the bottle or mouthpiece, the generated pitch of the sound also changes, i.e., changing the relative ‘springiness’ of the air within a Helmholtz resonator raises or lowers the resultant pitch of the sound that is produced. This resonator can be tuned due to the adjustability and therefore tenability of the mouthpiece.

A much neglected aspect of brass instrument mouthpiece design is that there is another resonance factor inherent to a brass instrument mouthpiece in addition to its being a Helmholtz resonator. This is the fact that the material comprising the mouthpiece has a resonance of its own, apart from the resonance of its interior. The musical performer, by playing the mouthpiece, vibrates both the air contained within the mouthpiece and the mouthpiece itself. The fundamental and harmonic resonances of the Helmholtz resonator and the mouthpiece itself combine to form a new frequency response of their own.

It is commonly known amongst musicians that it is difficult to find two mouthpieces of the same design that actually perform the same. Brass mouthpiece manufacturing processes aren't capable of consistently producing two mouthpieces exactly the same, so excellent performers will habitually try ten to fifty mouthpieces of the same model before finding two that will satisfy them as being equivalent. This is because the balance between the two resonating factors of the mouthpiece isn't addressed and/or optimized.

What is needed in the art, and provided by the present invention is, for a musician to be able to interchange four components of a mouthpiece (e.g. rim, cup, throat, and backbore) and for given set of components, (e.g. a rim, cup, throat, and backbore), the ability to balance and tune the mouthpiece by being able to adjust the cup depth, throat, and backbore independently of each other and further, have a throat tube that can be used as a fine tuning adjustment mechanism for the backbore.

### SUMMARY OF THE INVENTION

The present invention is constituted as described below to solve the above problems and achieve the objects.

The principal object of this invention is to provide a mouthpiece which can easily be balanced and tuned the by being able to adjust the cup depth, throat, and backbore independently of each other and further, have a throat tube that can be used as a fine tuning adjustment mechanism for the backbore.

A second object of this invention is to provide tunable mouthpiece of a brass instrument having a rim, a cup body, a throat tube insert, and a shanked backbore, wherein the throat tube insert is adjustably inserted into a backbore of the shanked backbore which forms a narrowest portion of the backbore.

A third object of this invention is to provide a rim adjustably attached to the cup body.

A forth object of this invention is to provide a rim that can be chosen from a set of rims having different thicknesses.

A fifth object of this invention is to provide a rim that can be locked in a desired position relative to said cup body by a bushing.

A sixth object of this invention provides a cup body and a rim forming a cup area producing a desired musical effect.

A seventh object of this invention provides a cup area that can be varied by choosing a rim of a desired thickness and a cup body with a desired cup shape and depth producing a desired musical effect.

A eighth object of this invention provides a cup area that can be adjusted given a rim of a desired thickness by changing the position of the rim to the cup body producing a desired musical effect.

A eighth object of this invention provides throat tube insert is removable and forms an airtight seal with the cup body and the shanked backbore.

A eighth object of this invention provides throat tube insert serves as a venture for the mouthpiece and can be produced having different lengths and a diameter of a throat tube bore to produce a desired musical effect.

A eighth object of this invention provides the shanked backbore having a backbore containing an area that can be varied by changing said diameter of the throat tube bore and the length of the throat tube insert producing a desired musical effect.

A eighth object of this invention provides an area of the backbore can be varied by changing the backbored shanks position relative to the cup body producing a desired musical effect.

In a second embodiment an object of the present invention provides a tunable mouthpiece of a brass instrument having a rim, a cup body that is separate from and adjustably attaches to the rim, a separable throat tube insert, and a backbored shank, consisting of a shank and a backbore, wherein the backbored shank holds the throat tube insert and adjustably attaches to the cup body, wherein the throat tube insert is adjustably inserted into a backbore of the shanked backbore forming a narrowest portion of the backbore, wherein the throat tube mates with the cup body and forms part of the backbore of the backbored shank.

A second object of the second embodiment of the present invention provides the throat tube insert is a functional part of the shanked backbore forming a narrowest portion of a backbore inside the shanked backbore.

A second object of the second embodiment of the present invention provides the rim adjustably attached to the cup body.

A second object of the second embodiment of the present invention provides the cup body and the rim form a cup area producing a desired musical effect.

A second object of the second embodiment of the present invention provides the cup area can be varied by choosing a rim of a desired thickness and a cup body with a desired cup shape and depth, wherein the cup area can be adjusted given a rim of a desired thickness by changing the position of the rim to the cup body producing a desired musical effect.

A second object of the second embodiment of the present invention provides the throat tube insert serves as a venture for the mouthpiece and can be produced have different lengths and a diameter of a throat tube bore to produce a desired musical effect.

A second object of the second embodiment of the present invention provides the shanked backbore has a backbore containing an area that can be varied by changing the diameter of the throat tube bore and the length of the throat tube insert producing a desired musical effect.

A second object of the second embodiment of the present invention provides the area of the backbore can be varied by changing the backbored shanks position relative to the cup body producing a desired musical effect.

In a third embodiment, an object of the present invention provides a tunable mouthpiece having a rim that is annular shaped and formed from a material, such as but not limited to, metal, plastic, or wood, wherein, the rim has an inner rim diameter and an outer rim diameter, a inner diameter and said outer diameter of said rim are chosen to a performers liking based on comfort and performance, wherein, a shape and contour of the inner rim diameter and a cup of a cup body are chosen for a desired musical effect, wherein, an overall area of the cup can be altered by screwing or attaching the rim to the cup body in varying amounts to change the overall area of the cup, a throat tube insert having a throat tube rim, a throat tube shaft, a throat tube length, and a throat tube bore, an outer diameter of the throat tube rim is sized forming an airtight seal when inserted into a throat tube receptacle of the cup body, a throat tube shaft is sized so that when inserted into an upper bore of a backbored shank the throat tube insert becomes part of the backbored shank and serves as a venturi for the mouthpiece that can be produced having different throat tube lengths and a different diameter throat tube bore, the cup body being coupled to a backbored shank via the throat tube, the backbored shank has an upper bore for receiving the throat tube, a receptacle which is sized so that its outer diameter accepts the throat tube rim and forms an airtight fit with the throat tube receptacle of the cup body, the backbore of the backbored shank is a bore running between the end of the mouthpiece and the throat tube allowing air to enter into the brass instrument, the backbored shank has a shank which is the outer surface of the backbored shank that inserts into the brass instrument, the throat tube bore forms the narrowest part of a backbore of the backbored shank and can be inserted at different depths into the backbore to produce a desired musical effect.

### BRIEF DESCRIPTION OF THE DRAWINGS

FIG. 1 (iii) is a simplified illustration of components of a tunable mouthpiece in an unassembled state;

FIG. 1 (A) is a cross-sectional view of the tunable mouthpiece of FIG. 1(iii) showing inner features of the components of the mouthpiece.

FIG. 1(B) shows the mouthpiece of FIG. 1 (iii) with a throat tube slightly inserted into a shanked backbore.

FIG. 1 (C) shows the mouthpiece of FIG. 1 (iii) with the throat tube inserted farther into the shanked backbore than in FIG. 2 (B).

FIG. 1 (D) is a cross-sectional view of the mouthpiece of FIG. 1 (C).

FIG. 1 (E) shows the mouthpiece of FIG. 1 (iii) depicting the throat tube fully inserted into the shanked bore.

FIG. 1 (F) is an illustration of the mouthpiece of FIG. 1 (iii) showing the throat tube, shanked backbore, and cup body assembled together.

FIG. 1 (G) is a cross-sectional view of the mouthpiece of FIG. 1 (F).

FIG. 1 (H) is an illustration of the mouthpiece of FIG. 1 (iii) showing the rim, cup body, throat tube, and shanked backbore assembled together.

FIG. 1 (I) is a cross-sectional view of the mouthpiece of FIG. 1 (H).

### DETAILED DESCRIPTION OF THE PREFERRED EMBODIMENTS

Embodiments of a tunable mouthpiece of a brass instrument of the present invention will be described below. Embodiments of the present invention show the most preferred embodiments of the invention and the present invention is not limited to these embodiments.

In one embodiment of the present invention, the throat tube, in particular, is designed so that this problem is addressed. Ideally, the combined frequency response of the two resonating factors within a mouthpiece would amplify harmonics of the same fundamental frequency. In one embodiment of the present invention, one would generally choose a mouthpiece combination of a cup, a rim and a shank that would produce a mouthpiece with desired characteristics, and then select a throat tube that optimizes the mouthpiece through optimizing the frequency response characteristics of the final mouthpiece. Very similar to the process of tuning strings of a piano, as you approach an optimal frequency response condition, a player can sense two resonance factors interacting through the amplification or cancelling of certain frequencies, affecting the way a mouthpiece responds. The closer one gets to a sympathetic frequency response situation, the more obvious the change in the mouthpiece. Ironically, the closer one gets to the ideal intonation of the mouthpiece the more obvious becomes the interaction between resonating factors and the more imperative that these factors are in sympathy with one another. This calls for a mechanism of very fine adjustment. For example, using my throat tube as the tuning mechanism, the difference of 1/10,000th of an inch in length can be the difference between a stable, clear sounding mouthpiece and an unstable, unfocused mouthpiece! Resonating factors within a mouthpiece would amplify the harmonics of the same fundamental frequency. The present invention does this by a musician or performer, choosing a mouthpiece combination of a cup, a rim and a shank that would produce a mouthpiece with desired characteristics, and then select a throat tube that optimizes the mouthpiece through optimizing the frequency response characteristics of the final mouthpiece. Very similar to the process of tuning the strings of a piano, as you approach the optimal frequency response condition, the player can sense the two resonance factors interacting through the amplification or cancelling of certain frequencies, affecting the way the mouthpiece responds. The closer one gets to a sympathetic frequency response situation, the more obvious the change in the mouthpiece. Ironically, the closer one gets to the ideal intonation of the mouthpiece the more obvious becomes the interaction between resonating factors and the more imperative that these factors are in sympathy with one another. This calls for a mechanism of very fine adjustment. For example, using a throat tube as one possible fine tuning mechanism, the difference of 1/10,000th of an inch in length can be the difference between a stable, clear sounding mouthpiece and an unstable, unfocused mouthpiece.

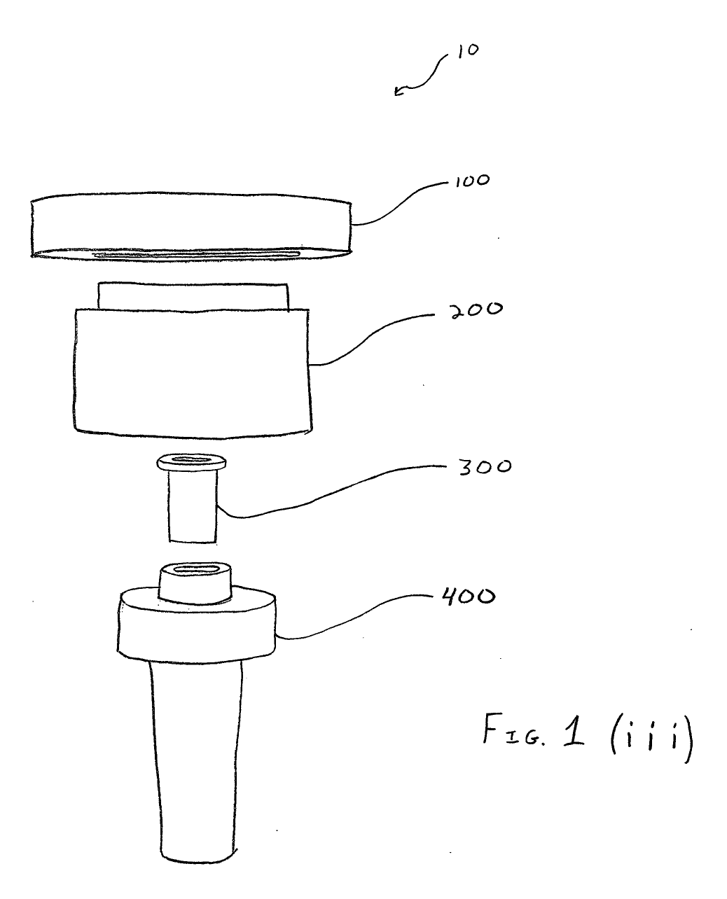

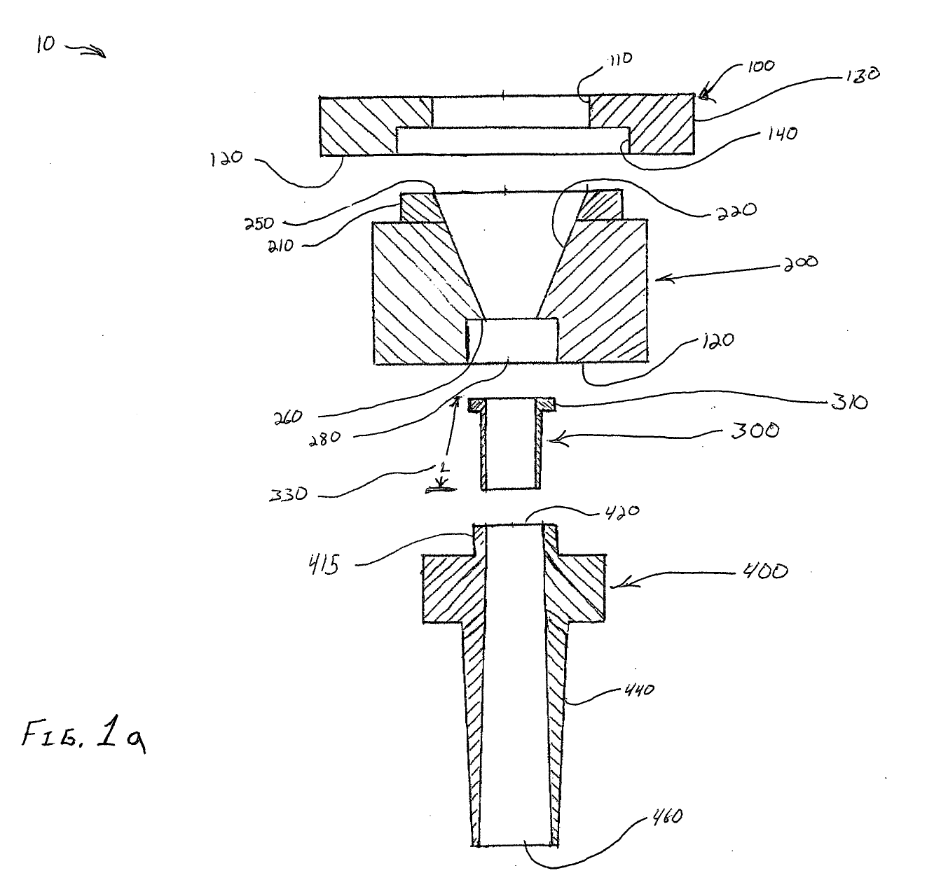

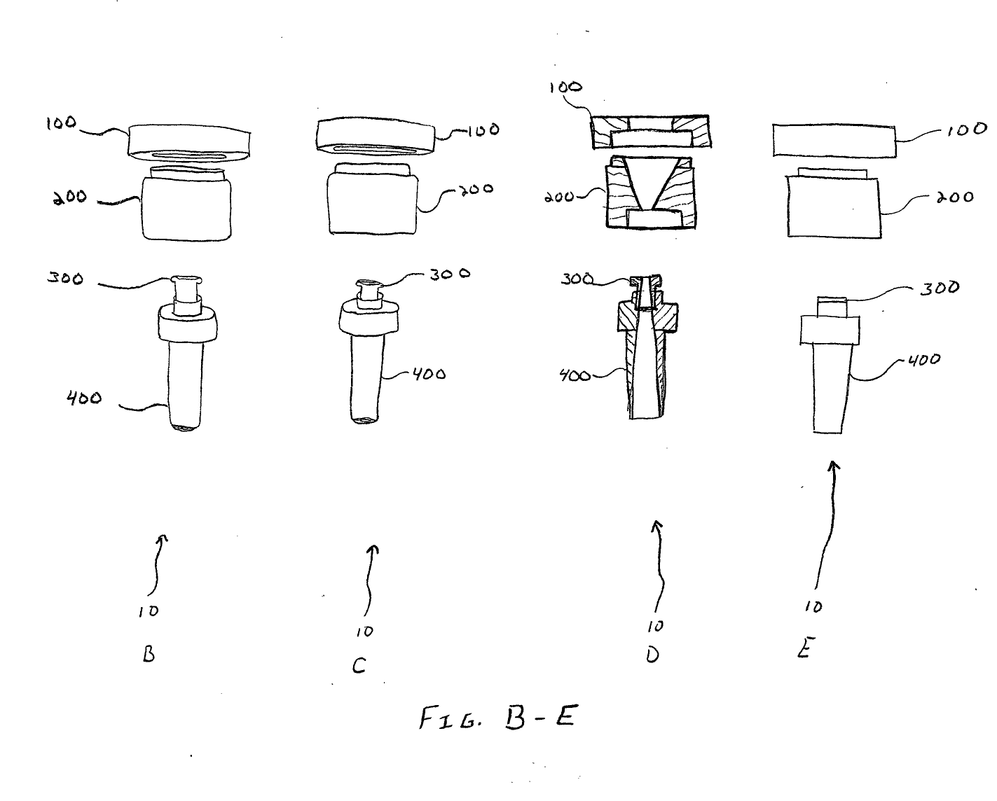

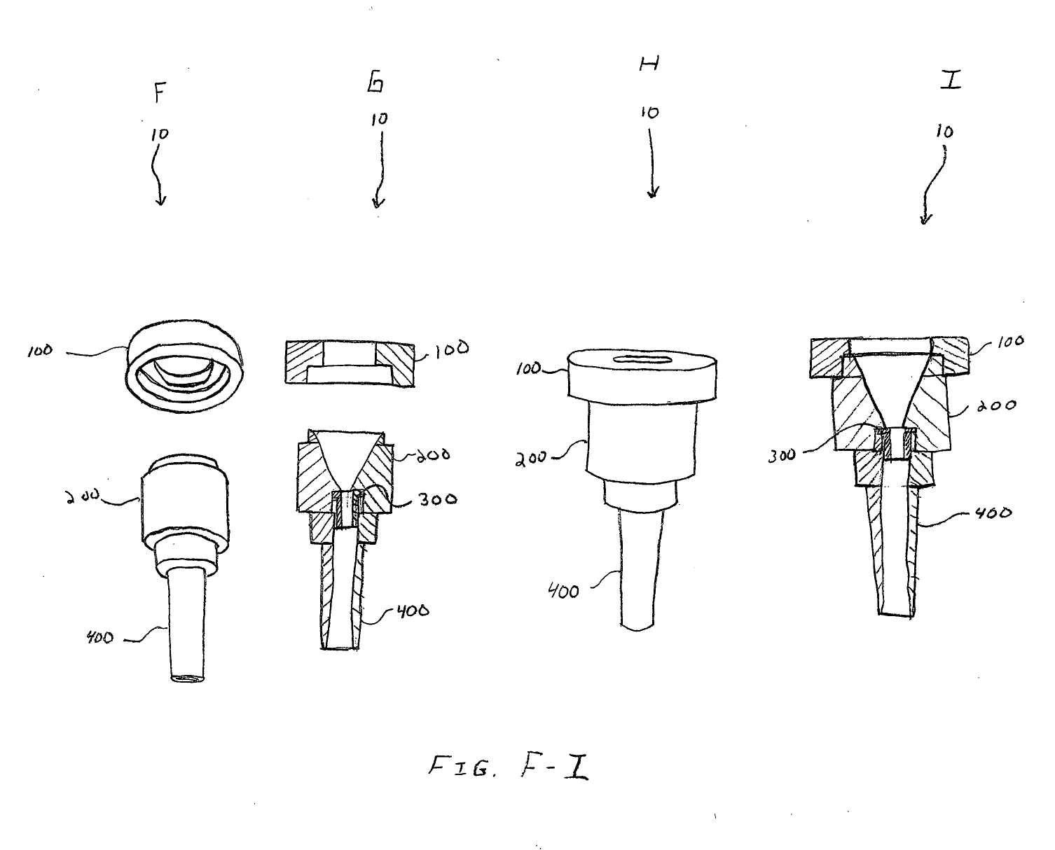

FIG. 1 (iii) is a simplified representation of an embodiment of a mouthpiece 10 of a brass or other similar instrument. The mouthpiece 10 is comprised of a rim 100, a cup body 200, a throat tube 300, and a shank/backbore 400. Each of the components of the mouthpiece 100, 200, 300, and 400 have particular effects upon the function of the mouthpiece and the manner in which these components and their features interact can give a musician/performer his or her desired musical capabilities. Therefore, it is advantageous to be able to manipulate these components and by doing so their interactions with each other. FIG. 1 (A) is a cross-sectional view of the mouthpiece shown in FIG. 1(iii), to show inner details of the mouthpiece 10 components.

In FIG. 1 (A), The rim 100 is annular shaped and formed from a material, such as but not limited to, metal, plastic, or wood and can have many different contours, i.e., smooth, rounded, square, etc. The rim 100 has an inner rim diameter 110 and an outer rim diameter 130. The inner diameter 110 and outer diameter 130 of the rim 100 can be varied in size and contour to a performers liking based on comfort and performance. A performer places their lips directly in contact with the rim 100 creating the performer's embouchure, which is the facial position a performer cultivates to use the mouthpiece 10.

A shape and contour of the inner rim diameter 110 and the cup 220 can be altered to produce a desired effect. Once a desirable inner rim diameter 110 and outer rim diameter 130 with their associated contours are chosen, a rim height, h 150 can be varied. Varying the rim height h 150 alters an overall area of the cup 240 which is formed by the inner rim diameter 110 and the cup 220. The overall area of the cup can be altered in several ways, for example: 1) by manufacturing and using multiple rims, that are identical except for height h 150; 2) by inserting a bushing or spacer (not shown) between the cup body 200 and rim 100 to change the area/depth of the overall cup 240; 3) by screwing or attaching the rim 100 to the cup body 200 in varying amounts to change the area/depth of the overall area of the cup 240.

In one embodiment, the cup body 200 attaches to the rim 100 by means of threading a cup interface 210 into a rim interface bore 140. The cup interface and rim interface bore can attach in other methods, such as but not limited to, a press fit, glued, or welded. The inner rim diameter 110 matches an upper cup diameter 250 of a cup 220 providing a smooth inner transition between the inner features of the rim 100 and cup body 200. The cup 220 can have a funnel shape with a hole through it or similar shape with a hole through it so air can flow through.

A throat tube insert 300 has a throat tube rim 310, a throat tube shaft, a throat tube length L 330, and a throat tube bore 320. An outer diameter of the throat tube rim 310 is sized so that it forms an airtight seal when inserted into a throat tube receptacle 280 of the cup body 200. A throat tube shaft 340 is sized so that when inserted into an upper bore 410 of a backbored shank 400 the throat tube insert 300 becomes part of the backbored shank 400 and serves as a venturi for the mouthpiece 10 that can be produced having different throat tube lengths L 330 and a different diameter throat tube bore 320 to get a desired musical effect. Due to the small size of the throat tube 300, it is easier to choose a throat tube 300 that will produce the desired musical results.

The cup body 200 is coupled to a backbored shank 400 via the throat tube 300. The backbored shank 400 has an upper bore 410 for receiving the throat tube 300, a receptacle 415 which is sized so that its outer diameter accepts the throat tube rim 310 and forms an airtight fit with the throat tube receptacle 280 of the cup body 200.

The backbore 460 of the backbored shank 400 is a bore running between the end of the mouthpiece 10 and the throat tube 300 allowing air to enter into the brass instrument. The backbored shank 400 has a shank 440 which is the outer surface of the backbored shank 400 that inserts into the brass instrument. The throat tube bore 320 forms the narrowest part of a backbore 460 of the backbored shank 400 and can be inserted at different depths into the backbore 460 to produce a desired musical effect. In other words, the backbored shank 400 can be moved forward or backward relative to the throat tube 300 creating a smaller or larger area within the backbore and also moving the narrowest portion of the backbore 460 of the mouthpiece to produce a desired musical effect. In one embodiment the area within the backbore 460 can be adjusted by how far the backbored shank 400 is screwed or pressed into the cup body 200, or by manufacturing backbored shank 400 pieces that are identical except for having different lengths L 330.

With any single combination of a rim 100, cup body 200, throat tube insert 300 and backbored shank 400, the mouthpiece 10 allows for an adjustable venturi, an adjustable backbore 460 and an adjustable cup 220 allowing the mouthpiece to be fine tuned.

In a preferred embodiment, a musician (performer) begins by choosing a rim 100 and a cup body 200 that feels comfortable on their lips and produces a timbre, articulation and tessitura that is desired. The musician would then select a throat tube 300 and backbored shank 400 that when coupled to the rim 100 and cup body 200 produce the desired musical effect. Once a musician has selected the desired parts of the mouthpiece 10 the musician can fine tune the mouthpiece 10 by adjusting how far the rim 100 is screwed on the cup body 200 and/or with a given throat tube 300 how much the backbored shank 400 is screwed on the cup body200.

In other words, to fine tune the cup 220 (cup depth) one can wither screw the rim 100 onto the cup body more or less and/or use a bushing or other securing mechanism to keep this setting intact, or can select a different rim with a different height h 150, effectively creating a larger or smaller area (cup 220) within the mouthpiece 10. To fine tune the throat tube 300 and backbore 460, one can select and insert a different throat tube 300 having a different length L 330 and/or backbore 460 along with adjusting the amount the backbored shank 400 is screwed or pressed into the cup body 200.

FIG. 1 (B) through FIG. 1 (I) demonstrates one embodiment or one possible method of assembling the mouthpiece 10. FIG. 1 (B) through FIG. 1 (E) shows the throat tube 300 inserted into the shanked backbore 400 at different depths of insertion. This allows for the minute adjustments in the throat tube 300 position (i.e. 1 to 2 ten thousands of an inch) therefore giving the musician/performer the ability to fine tune the backbore of the backbored shank 400 via the throat tube 300, therefore fine tuning the mouthpiece 10. Being able to choose a throat tube 300 that varies by only by 1/10,000 of an inch along with the ability to insert it at different lengths allows for super fine tuning of the mouthpiece 10. FIG. 1 (B) shows the FIG. 1 (F) shows the backbored shank 300 attached to the cup body 200. FIG. 1 (G) illustrates a cross-sectional view of FIG. 1 (F) showing the throat tube 300 in place between the cup body 200 and the backbored shank 400.

FIG. 1 (H) illustrates the completely assembled mouthpiece 10 and FIG. 1 (I) is a cross-sectional view of FIG. 1 (H) showing the inner features of the mouthpiece 10.

1. A tunable mouthpiece of a brass instrument comprising:
a rim;
a cup body;
a throat tube insert; and,
a shanked backbore, wherein said throat tube insert is adjustably inserted into a backbore of said shanked backbore forming a narrowest portion of said backbore.

2. A mouthpiece according to claim 1, wherein said rim is adjustably attached to said cup body.

3. A mouthpiece according to claim 2, wherein said rim can be chosen from a set of rims having a different thickness.

4. A mouthpiece according to claim 3, wherein said rim is locked in a desired position relative to said cup body by a bushing.

5. A mouthpiece according to claim 1, wherein said cup body and said rim form a cup area producing a desired musical effect.

6. A mouthpiece according to claim 5, wherein said cup area can be varied by choosing a rim of a desired thickness and a cup body with a desired cup shape and depth producing a desired musical effect.

7. A mouthpiece according to claim 6, wherein said cup area can be adjusted given a rim of a desired thickness by changing the position of said rim to said cup body producing a desired musical effect.

8. A mouthpiece according to claim 1, wherein said throat tube insert is removable and forms an airtight seal with said cup body and said shanked backbore.

9. A mouthpiece according to claim 8, wherein said throat tube insert serves as a venture for said mouthpiece and can be produced have different lengths and a diameter of a throat tube bore to produce a desired musical effect.

10. A mouthpiece according to claim 9, wherein said shanked backbore has a backbore containing an area that can be varied by changing said diameter of said throat tube bore and said length of said throat tube insert producing a desired musical effect.

11. A mouthpiece according to claim 10, wherein said area of said backbore can be varied by changing said backbored shanks position relative to said cup body producing a desired musical effect.

12. A tunable mouthpiece of a brass instrument comprising:
A rim;
A cup body that is separate from and adjustably attaches to said rim;
A separable throat tube insert; and
A backbored shank, consisting of a shank and a backbore,
wherein said backbored shank holds said throat tube insert and adjustably attaches to said cup body,
wherein said throat tube insert is adjustably inserted into a backbore of said shanked backbore forming a narrowest portion of said backbore,
wherein said throat tube mates with said cup body and forms part of said backbore of said backbored shank.

13. A mouthpiece according to claim 12, wherein said throat tube insert is a functional part of said shanked backbore forming a narrowest portion of a backbore inside said shanked backbore.

14. A mouthpiece according to claim 13, wherein said rim is adjustably attached to said cup body.

15. A mouthpiece according to claim 14, wherein said cup body and said rim form a cup area producing a desired musical effect.

16. A mouthpiece according to claim 15, wherein said cup area can be varied by choosing a rim of a desired thickness and a cup body with a desired cup shape and depth, wherein said cup area can be adjusted given a rim of a desired thickness by changing the position of said rim to said cup body producing a desired musical effect.

17. A mouthpiece according to claim 16, wherein said throat tube insert serves as a venture for said mouthpiece and can be produced have different lengths and a diameter of a throat tube bore to produce a desired musical effect.

18. A mouthpiece according to claim 17, wherein said shanked backbore has a backbore containing an area that can be varied by changing said diameter of said throat tube bore and said length of said throat tube insert producing a desired musical effect.

19. A mouthpiece according to claim 18, wherein said area of said backbore can be varied by changing said backbored shanks position relative to said cup body producing a desired musical effect.

20. A tunable mouthpiece comprising:
a rim that is annular shaped and formed from a material, such as but not limited to, metal, plastic, or wood, wherein, said rim has an inner rim diameter and an outer rim diameter, said inner diameter and said outer diameter of said rim are chosen to a performers liking based on comfort and performance, wherein, a shape and contour of said inner rim diameter and a cup of a cup body are chosen for a desired musical effect, wherein, an overall area of said cup can be altered by screwing or attaching said rim to the cup body in varying amounts to change said overall area of the cup,
a throat tube insert having a throat tube rim, a throat tube shaft, a throat tube length, and a throat tube bore, an outer diameter of said throat tube rim is sized forming an airtight seal when inserted into a throat tube receptacle of said cup body, a throat tube shaft is sized so that when inserted into an upper bore of a backbored shank said throat tube insert becomes part of said backbored shank and serves as a venturi for said mouthpiece that can be produced having different throat tube lengths and a different diameter throat tube bore, said cup body being coupled to a backbored shank via said throat tube, said backbored shank has an upper bore for receiving said throat tube, a receptacle which is sized so that its outer diameter accepts said throat tube rim and forms an airtight fit with said throat tube receptacle of said cup body, said backbore of said backbored shank is a bore running between an end of said mouthpiece and said throat tube allowing air to enter into a brass instrument, said backbored shank has a shank which is an outer surface of said backbored shank that inserts into said brass instrument, said throat tube bore forms the narrowest part of a backbore of said backbored shank and can be inserted at different depths into said backbore to produce a desired musical effect.
